(19) United States
(12) Patent Application Publication
(10) Pub. No.: US 2006/0061788 A1
(43) Pub. Date: Mar. 23, 2006

(54) Image processing apparatus

(75) Inventor: Gaku Takano, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/945,426

(22) Filed: Sep. 21, 2004

(51) Int. Cl. G06F 15/00

(52) U.S. Cl. 358/1.13

(57) ABSTRACT

An image processing apparatus executes at least one of a copy operating mode, a scan operating mode, and a printer operating mode to process an image using an image processing unit and stores image data generated when the image is processed. The apparatus has a net ready image processing mode in which the stored image data is processed using one of the image processing unit and a computing unit which processes image data.

### BACKGROUND OF THE INVENTION

1. Field of the Invention

The present invention relates to an image processing apparatus.

2. Description of the Related Art

Image processing apparatuses, such as multi-function peripherals (MFP) having a number of functions such as a copy function, a scan function and a printer function, are known. Some of the image processing apparatuses, which have operating modes for performing three image processings to fulfill the copy, scan and printer functions and a net ready image processing mode, are known. The net ready image processing mode is an operating mode for processing image data stored in a page memory or processing image data sent from outside via a network or the like and then returning it to a sender. An image processing apparatus having such a net ready image processing mode achieves its image processing using an image processing unit that is formed of hardware (HW) provided therein. In other words, the apparatus uses the image processing unit to process an image in the net ready image processing mode through a HW path.

Since the image processing apparatus has only the HW path to process an image in the net ready image processing mode as described above, its processing efficiency sometimes decreases-because of resource competition of the image processing unit. For example, this phenomenon appears in a case where a request for each of copy, scan and print jobs is issued in the net ready image processing mode. The reason why this case occurs is that the image processing unit needs to be freed up for execution of a higher-priority job and thus the apparatus needs to abandon a job of the net ready image processing mode. The phenomenon appears in another case where a job of net ready image processing is issued when the copy, scan and print jobs are executed. The reason why this case occurs is that the image processing unit is in use and thus the apparatus has to wait for the start of the job of the net ready image processing.

Accordingly, there is a need for an image processing apparatus capable of avoiding the resource competition of an image processing unit to prevent a decrease in processing efficiency when an image is processed in the net ready image processing mode.

### BRIEF SUMMARY OF THE INVENTION

According to one aspect of the present invention, there is provided An image processing apparatus comprising an image processing unit which processes image data, a computing unit configured to process image data, a first mode control unit configured to execute at least one of a copy operating mode, a scan operating mode and a printer operating mode to process an image using the image processing unit, an image data storage unit which stores image data generated when an image is processed in the one of the copy operating mode, the scan operating mode and the printer operating mode, and a second mode control unit configured to execute a net ready image processing mode in which the image data stored in the image data storage unit is processed using one of the image processing unit and the computing unit.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a schematic diagram showing a configuration of an image processing apparatus according to a first embodiment of the present invention.

FIG. 2 is a schematic diagram showing a configuration of a control unit in the first embodiment.

FIG. 3 is a diagram functionally showing a configuration of an image processing unit in the first embodiment.

FIG. 4 is a block diagram showing a flow of image data in copy operation in the first embodiment.

FIG. 5 is a block diagram showing a flow of image data in scan operation in the first embodiment.

FIG. 6 is a block diagram showing a flow of image data in printer operation in the first embodiment.

FIG. 7 is a block diagram showing a flow of image data when an image is processed through a hardware path in a net ready image processing mode in the first embodiment.

FIG. 8 is a block diagram showing a flow of image data when an image is processed through a software path in the net ready image processing mode in the first embodiment.

FIG. 9 is a time chart indicative of timing when image data is processed in copy operation in the first embodiment.

FIG. 10 is a time chart indicative of timing of image data processing in the net ready image processing mode in the first embodiment.

FIG. 11 is a time chart indicative of timing of image data processing when a net ready image processing job occurs in copy operation in the first embodiment.

FIG. 12 is a time chart indicative of timing of image data processing when a copy job occurs in the net ready image processing mode in the first embodiment.

FIG. 13 is a schematic diagram showing a configuration of an image processing apparatus according to a second embodiment of the present invention.

FIG. 14 is a diagram showing a structure of functions added to the control unit in the second embodiment.

### DETAILED DESCRIPTION OF THE INVENTION

Embodiments of the present invention will be described below with reference to the drawings.

### First Embodiment

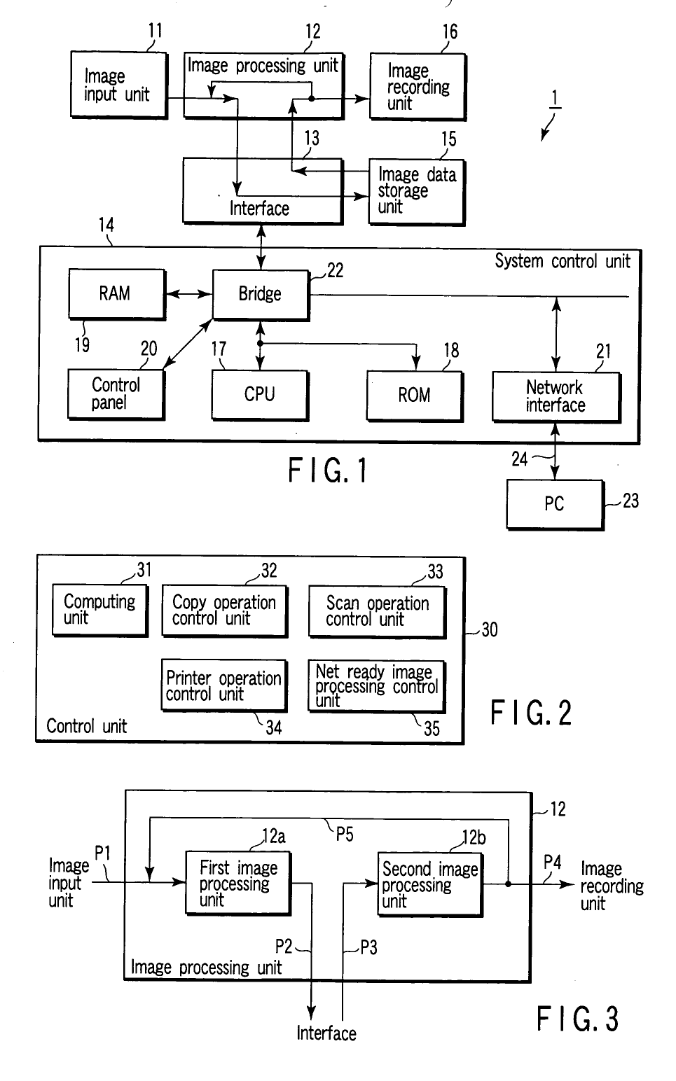

FIG. 1 is a schematic diagram showing a configuration of an image processing apparatus 1. The image processing apparatus 1 includes an image input unit 11, an image processing unit 12, an interface 13, a system control unit 14, an image data storage unit 15 and an image recording unit 16. The image input unit 11 is, for example, a flat head scanner formed by a line CCD and converts a document image into image data. The image processing unit 12 receives at least one input from the image input unit 11 and transmits at least one output to the image recording unit 16. The image processing unit 12 processes the input image data and outputs the processed image data. The interface 13 transmits/receives data to/from the image processing unit 12, image data storage unit 15 or system control unit 14. The image data storage unit 15 is, for example, a page memory and stores image data. The image recording unit 16 is, for example, a laser printer of an electrophotographic recording type and records an image on a paper sheet for each page based on the input image data.

The system control unit 14 has a CPU 17, a ROM 18, a RAM 19, a control panel 20, a network interface 21 and a bridge 22.

The CPU 17 controls the respective units of the image processing apparatus 1 as a whole based on control programs and fixed data stored in the ROM 18. The control programs and fixed data stored in the ROM 18 are executed by the CPU 17. The RAM 19 serves as a memory when the CPU 17 executes the control programs stored in the ROM 18. The control panel 20 is a user interface and receives various instructions from a user. The network interface 21 communicates with, e.g., a computer device (PC) 23 connected to a network 24. The bridge 22 combines signals transferred between the devices in the system control unit 14.

With the above configuration, the system control unit 14 controls transmission and reception of data performed via the network 24 and an operation of each of the image input unit 11, image processing unit 12, interface 13, image data storage unit 15 and image recording unit 16. These units are controlled by the CPU 17, ROM 18 and RAM 19. FIG. 2 is a diagram functionally showing a control unit 30 configured by the CPU 17, ROM 18 and RAM 19. The control unit 30 includes a computing unit 31, a copy operation control unit 32, a scan operation control unit 33, a printer operation control unit 34 and a net ready image processing control unit 35.

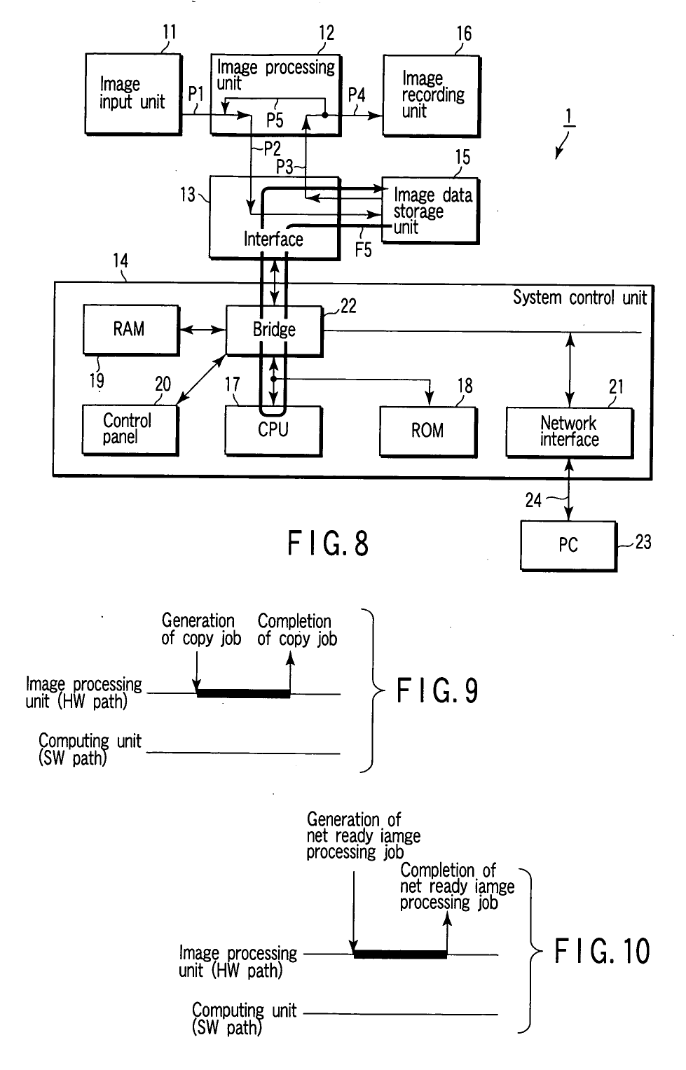

The computing unit 31 processes image data. The computing unit 31 can include an image data processing circuit as an auxiliary computing unit, and computing unit 31 may process an image using the auxiliary computing unit. The copy operation control unit 32 performs control to implement a copy operating mode in which the respective units of the image processing apparatus 1 operate to make a copy. The scan operation control unit 33 performs control to implement a scan operating mode in which the respective units of the image processing apparatus 1 operate to make a scan. The printer operation control unit 34 performs control to implement a printer operating mode in which the respective units of the image processing apparatus 1 operate to record an image based on print data received from the PC 23 via the network 24. The net ready image processing control unit 35 performs control to implement a net ready image processing mode in which the image data stored in the image data storage unit 15 is processed using one of the image processing unit 12 and the computing unit 31. The flow of image data in the net ready image processing mode will be described in detail later with reference to FIGS. 7 and 8.

FIG. 3 is a schematic diagram showing a configuration of the image processing unit 12. The image processing unit 12 has a first image processing unit 12a and a second image processing unit 12b. The image processing unit 12 also has paths P1 to P5 as routes for processing image data. The path P1 is a route for supplying image data from the image input unit 11 to the first image processing unit 12a. The path P2 is a route for supplying the image data processed by the first image processing unit 12a to the interface 13. The path P3 is a route for supplying the image data from the interface 13 to the second image processing unit 12b. The path P4 is a route for supplying the image data processed by the second image processing unit 12b to the image recording unit 16. The path P5 is a route for supplying the image data processed by the second image processing unit 12b to the first image processing unit 12a. The first image processing unit 12a performs a scaling operation, a color conversion operation, a filtering operation, an encoding operation and the like. The second image processing unit 12b performs a combining operation, a filtering operation, a gamma correction operation, a gray-scale operation and the like.

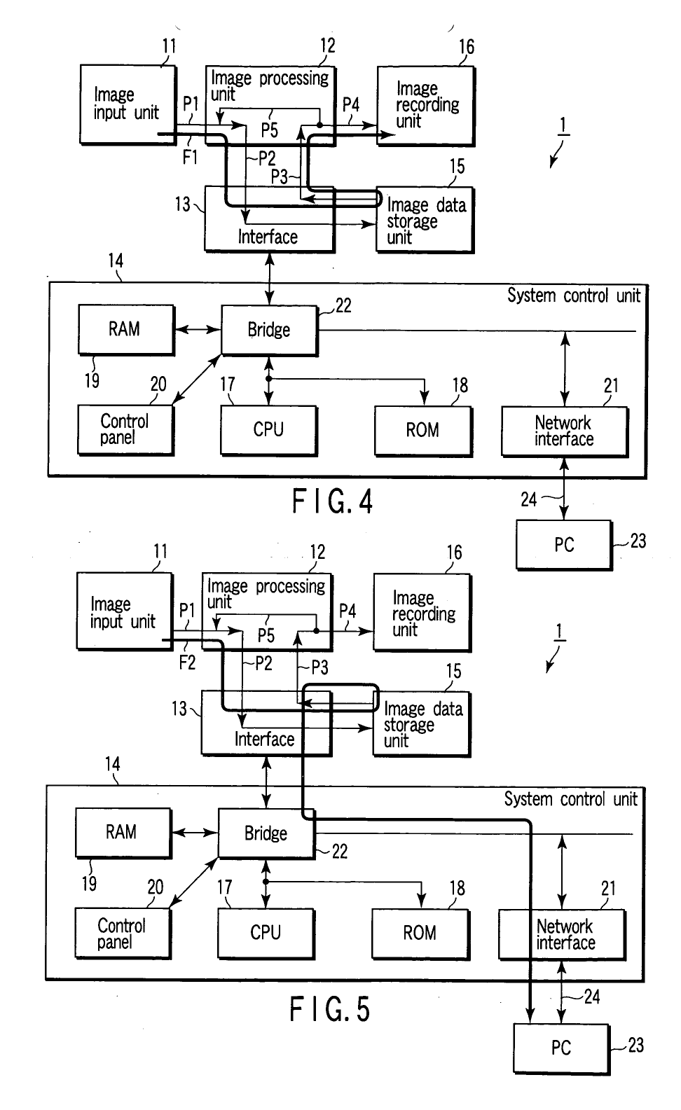

FIG. 4 is a diagram showing a flow F1 of image data in the copy operating mode. In copy operation, the image data output from the image input unit 11 is supplied to the image processing unit 12 through the path P1 and processed by the first image processing unit 12a. After that, the processed image data is supplied to the interface 13 through the path P2 and stored in the image data storage unit 15 through the interface 13. Then, the stored image data is supplied to the image processing unit 12 from the interface 13 through the path P3 in response to an instruction of the system control unit 14. This image data is processed by the second image processing unit 12b and then supplied to the image recording unit 16 through the path P4.

FIG. 5 is a diagram showing a flow F2 in the scan operating mode. In scan operation, the image data output from the image input unit 11 is supplied to the image processing unit 12 through the path P1 and processed by the first image processing unit 12a. After that, the processed image data is supplied to the interface 13 through the path P2 and stored in the image data storage unit 15 through the interface 13. In response to an instruction from the control panel 20 or an instruction from the PC 23 via the network 24, the system control unit 14 supplies the recorded image data to the outside via the network 24.

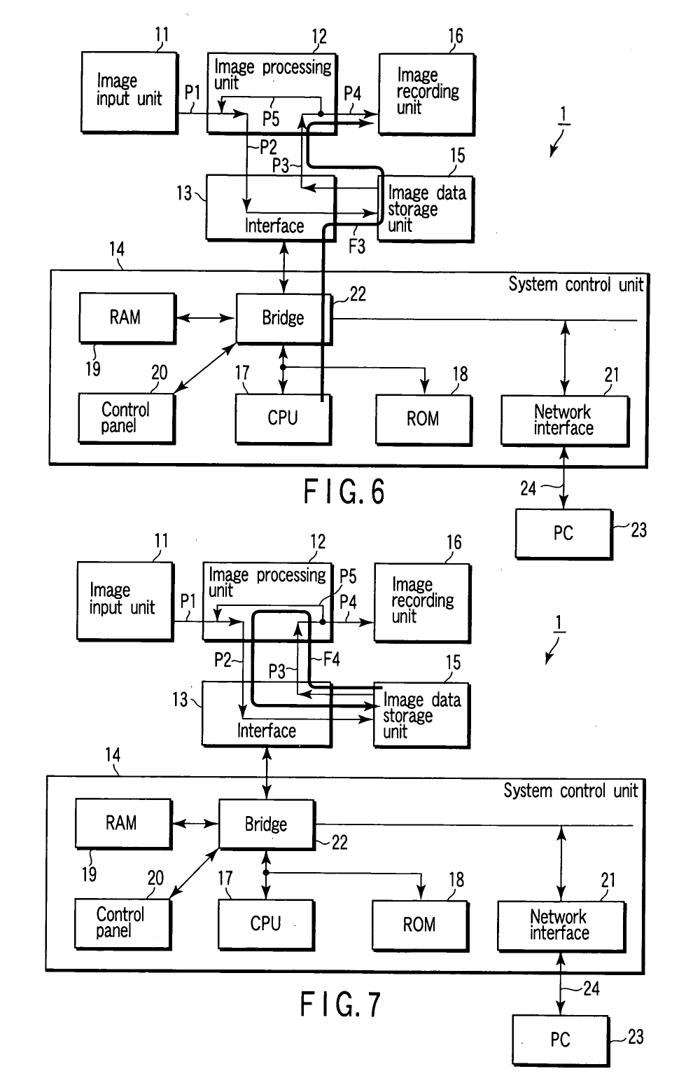

FIG. 6 is a diagram showing a flow F3 of image data in the printer operating mode. In printer operation, the system control unit 14 generates image data based on a print job received via the network 24. The generated image data is stored in the image data storage unit 15 through the interface 13. Then, the stored image data is supplied to the image processing unit 12 through the path P3 in response to an instruction of the system control unit 14. This image data is processed by the second image processing unit 12b of the image processing unit 12 and then supplied to the image recording unit 16 through the path P4.

Referring next to FIGS. 7 and 8, a flow of image data in the net ready image processing mode will be described. In the net ready image processing mode, the image data stored in the image data storage unit 15 is processed and then stored in the image data storage unit 15 again through the interface 13. In response to an instruction of the system control unit 14, the stored image data is maintained, recorded by the image recording unit 16, or transmitted to the PC 23 through the network 24. The image processing in the net ready image processing mode is performed using the path P5 described above and, in other words, it is done through a hardware (HW) path using the image processing unit 12 and a software (SW) path using the computing unit 31 in the system control unit 14.

First, an operation performed through the HW path will be described. FIG. 7 is a diagram showing a flow F4 of image data in this operation. In response to an instruction of the system control unit 14, the image data stored in the image data storage unit 15 is transferred to the image processing unit 12 from the interface 13 through the path P3 and processed by the second image processing unit 12b. After that, the image data is input to the first image processing unit 12a through the path P5 and processed therein. Then, the image data is transmitted to the interface 13 through the path P2. This image data is supplied from the interface 13 to the image data storage unit 15 and stored again therein. In response to an instruction from the control panel 20 or an instruction from the PC 23 via the network 24, the system control unit 14 maintains the stored image data or supplies the image data to the outside via the network 24.

Next, an operation performed through the SW path will be described. FIG. 8 is a diagram showing a flow F5 of image data in this operation. In response to an instruction of the system control unit 14, the image data stored in the image data storage unit 15 is transferred to the CPU 17 from the interface 13 through the bridge 22 in the system control unit 14. The image data is processed by the CPU 17, ROM 18 and RAM 19 and then transmitted to the interface 13 through the bridge 22. The image data is supplied from the interface 13 to the image data storage unit 15 and stored again therein. In response to an instruction from the control panel 20 or an instruction from the PC 23 via the network 24, the system control unit 14 maintains the stored image data or supplies the image data to the outside via the network 24.

Since the image processing apparatus 1 has a net ready image processing mode as described above, it can reprocess the image data generated in the image data storage unit 15 in copy, scan and printer operations. For example, in the HW path, the image data in the image data storage unit 15 is supplied to the second image processing unit 12b through the path P3 and combined. The image data is transmitted to the first image processing unit 12a through the path P5, and scaled and filtered. Then, the image data is encoded and returned to the image data storage unit 15 through the path P2. In the SW path, too, the CPU 17 can perform the same processing (i.e., the computing unit 31 can do it). With the process described above, the images stored in the image data storage unit 15 are improved in quality and their format is converted in the HW path or SW path.

Next, an explanation of image processing using both the HW and SW paths will be given.

First, an explanation will be given of timing of image processing in the copy operating mode and that of image processing in the net ready image processing mode when these processings do not compete with each other. FIG. 9 is a time chart indicative of timing of image processing in copy operation. When a copy job occurs, the image processing unit 12 starts image processing. It performs the image processing in the image processing unit 12 until the job ends. FIG. 10 is a time chart indicative of timing of image processing in the net ready image processing mode. When a net ready image processing job occurs, the image processing unit 12 starts image processing. It performs the image processing in the image processing unit 12 until the job ends. When these jobs do not compete with each other, the HW path is used to perform the image processing.

Next, an explanation will be given of timing of image processing in the copy operating mode and that of image processing in the net ready image processing mode when these processings compete with each other.

FIG. 11 is a time chart indicative of timing of image processing in the copy operating mode when a net ready image processing job occurs. As shown in FIG. 11, the image processing in the copy operating mode is performed through the HW path. The image processing in the net ready image processing mode is performed through the SW path from when a job occurs until it ends. When the jobs compete with each other, the image processing apparatus 1 can perform the respective image processings in parallel. Accordingly, the image processing apparatus 1 improves in processing efficiency.

The image processing has been described with reference to FIG. 11 assuming that a net ready image processing job occurs in copy operation. However, when a net ready image processing job occurs in scan operation or printer operation, the “copy” can be replaced with “scan” or “printer” in FIG. 11 and, in this case, too, the same image processing can be performed with the same timing as in the copy operation. When a net ready image processing job occurs in scan operation or printer operation, the image processing in the net ready image processing mode is performed through the SW path. Consequently, when the net ready image processing job competes with the printer job or the scan job, the image processing apparatus 1 can perform the respective image processings in parallel. Accordingly, the image processing apparatus 1 improves in processing efficiency.

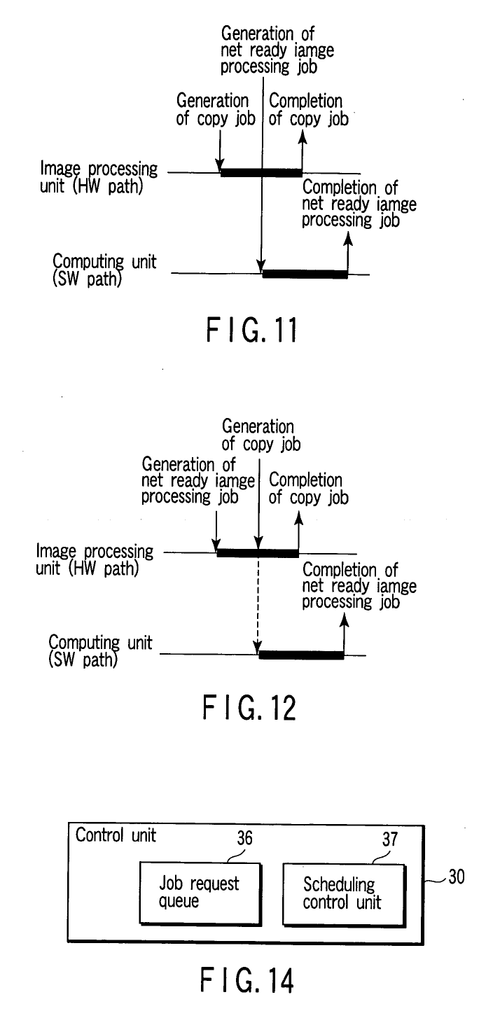

FIG. 12 is a time chart indicative of timing of image processing in the net ready image processing mode when a copy job occurs. As shown in FIG. 12, the image processing in the net ready image processing mode is performed through the HW path. If a copy job occurs, the system control unit 14 stops the image processing and changes the HW path to the SW path to perform the subsequent processing. The image processing with the copy job is performed through the HW path, while the image processing with the net ready image processing job is done through the SW path. When these jobs compete with each other, the image processing apparatus 1 can perform the respective image processings in parallel. Accordingly, the image processing apparatus 1 improves in processing efficiency.

The image processing has been described with reference to FIG. 12 assuming that a copy job occurs in the net ready image processing mode. However, when a scan job or a print job occurs at the time of image processing in the net ready image processing mode, the “copy” can be replaced with “scan” or “printer” in FIG. 12 and, in this case, too, the same image processing can be performed with the same timing as in the copy operation. When a scan job or a printer job occurs at the time of image processing in the net ready image processing mode, the image processing performed through the HW path of the net ready image processing job is stopped, and the HW path is changed to the SW path to perform the image processing. The scan job or the printer job is executed by the HW path. Consequently, when the net ready image processing job competes with the scan job or the printer job, the image processing apparatus 1 can perform the respective image processings in parallel. Accordingly, the image processing apparatus 1 improves in processing efficiency.

### Second Embodiment

A second embodiment will now be described. The same units as those of the foregoing embodiment are denoted by the same reference numerals and their detailed descriptions are omitted.

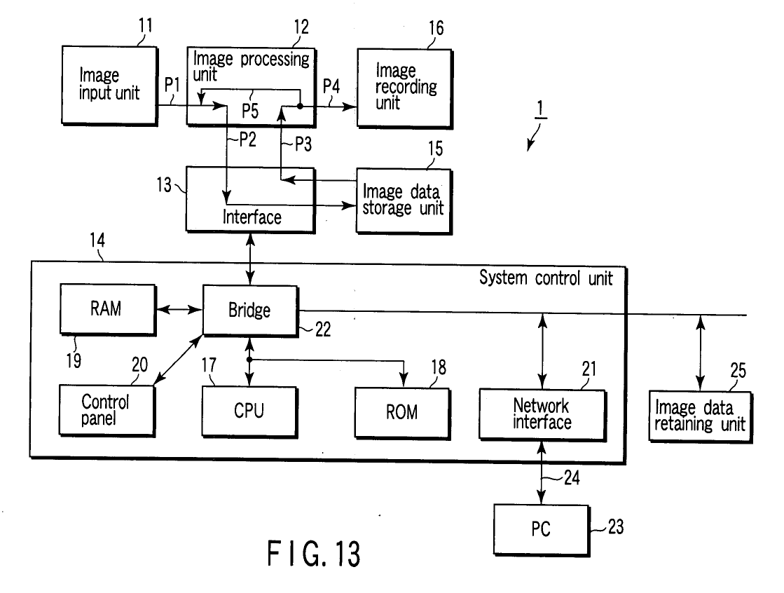

FIG. 13 is a schematic diagram showing a configuration of an image processing apparatus 1 according to the second embodiment. As shown in FIG. 13, an image data retaining unit 25 is added to the configuration illustrated with reference to FIG. 1. The image data retaining unit 25 is connected to a bridge 22 through a bus.

FIG. 14 is a diagram of functions added to a control unit 30 in the second embodiment. The control unit 30 includes a job request queue 36 and a scheduling control unit 37. The functions illustrated with reference to FIG. 2 are omitted from FIG. 14. The job request queue 36 stores the jobs of copy, scan, printer, and net ready image processing operations. The scheduling control unit 37 schedules a job based on the jobs stored in the job request queue 36.

An operation of the image processing apparatus 1 so configured will be described. As has been described with reference to FIGS. 11 and 12, a plurality of jobs are placed in the job request queue 36 when the jobs compete with each other. The image processing apparatus 1 schedules and executes the jobs as to the sequence of execution of the jobs placed in the queue 36 and the selection between a HW path and a SW path based on a predetermined evaluation function in such a manner that its evaluation value is optimized. The scheduling control unit 37 uses the image data retaining unit 25 as one for temporarily storing image data when the image data storage unit 15 is competed, which for storing image data to be processed.

The predetermined evaluation function is, for example, as follows. The evaluation function is used to evaluate an execution time of each of the jobs placed in the job request queue 36. In other words, it provides an expected processing time for processing each of the jobs. The evaluation function is also used to evaluate an execution time of a job other than the jobs for the net ready processing operation, which are included in the jobs placed in the job request queue 36. In other words, it provides the total sum of expected processing times of only the copy, scan or printer job when priority is given to the processing efficiency of basic operations of the image processing apparatus 1, such as the copy, scan and printer operations.

As described above, the image processing apparatus 1 includes the SW path using a computing unit 31 in addition to the HW path using an image processing unit 12 in order to process an image in the net ready image processing mode. When the net ready processing job do not compete with the copy job, the scan job, or printer job the apparatus 1 processes an image in the net ready image processing mode through the HW path. However, when the jobs compete with each other, a higher-priority copy, scan or printer job is executed through the HW path and a job for the net ready image processing is done through the SW path. The job for the net ready image processing is processed as one job of a multitask operation, thereby lessening a decrease in the processing efficiency of the image processing apparatus 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An image processing apparatus comprising:
an image processing unit which processes image data;
a computing unit configured to process image data;
a first mode control unit configured to execute at least one of a copy operating mode, a scan operating mode and a printer operating mode to process an image using the image processing unit;
an image data storage unit which stores image data generated when an image is processed in the one of the copy operating mode, the scan operating mode and the printer operating mode; and
a second mode control unit configured to execute a net ready image processing mode in which the image data stored in the image data storage unit is processed using one of the image processing unit and the computing unit.

2. The image processing unit according to claim 1, wherein when image processing of the first mode control unit and that of the second mode control unit compete with each other, the first mode control unit processes an image using the image processing unit and the second mode control unit processes an image using the computing unit.

3. An image processing apparatus comprising:
an image input unit which converts a document into image data;
an image recording unit which records image data;
an image processing unit which receives at least one input from the image input unit and transmits at least one output to the image recording unit to process image data;
an image data storage unit which stores image data;
a transmit/receive unit which transmits/receives data via a network;
a system control unit having a computing unit which processes an image, the system control unit controlling an operation of each of the image input unit, the image recording unit, the image processing unit, and the image data storage unit;
an interface which transfers data between the image processing unit, the image data storage unit, and the system control unit;
a copy operating mode in which the image data output from the image input unit is processed by the image processing unit in response to an instruction of the system control unit, and the processed image data is stored in the image data storage unit via the interface, and the image data is transferred to the image recording unit from the image data storage unit via the interface and recorded therein;
a scan operating mode in which the image data output from the image input unit is processed by the image processing unit in response to an instruction of the system control unit, the processed image data is stored in the image data storage unit via the interface, and the stored image data is output to an outside via the transmit/receive unit;
a printer operating mode in which a print job is received via the transmit/receive unit to generate image data in response to an instruction of the system control unit, the image data is supplied to the image processing unit via the interface and processed therein, and the processed image data is transferred to the image recording unit and recorded therein; and
a net ready image processing mode in which the image data stored in the image data storage unit is transferred to one of the image processing unit via the interface and the computing unit of the system control unit and processed in response to an instruction of the system control unit, and the processed image data is stored in the image data storage unit via the interface, thereby to perform one of operations of maintaining the image data stored in the image data storage unit, recording the image data by the image recording unit, and supplying the image data to an outside via the transmit/receive unit.

4. The image processing apparatus according to claim 3, wherein the image data stored in the image data storage unit in the net ready image processing mode is image data stored in the copy operating mode.

5. The image processing apparatus according to claim 3, wherein the image data stored in the image data storage unit in the net ready image processing mode is image data stored in the scan operating mode.

6. The image processing apparatus according to claim 3, wherein the image data stored in the image data storage unit in the net ready image processing mode is image data stored in the printer operating mode.

7. The image processing apparatus according to claim 3, wherein the image data stored in the image data storage unit in the net ready image processing mode is image data received from outside via the transmit/receive unit and then stored via the interface.

8. The image processing apparatus according to claim 3, further comprising a user interface to receive an instruction to perform at least one of a copy operation in the copy operating mode, a scan operation in the scan operating mode, and an operation in the net ready image processing mode.

9. The image processing apparatus according to claim 3, wherein image processing in the net ready image processing mode is performed upon receipt of an instruction from outside via the transmit/receive unit.

10. The image processing apparatus according to claim 3, wherein image processing in the net ready image processing mode is at least one or more of an extending operation, an image quality adjusting operation, a scaling operation, and a compressing operation.

11. The image processing apparatus according to claim 8, wherein if the user interface gives an instruction in image processing in the net ready image processing mode when one of the copy operating mode, the scan operating mode, and the printer operating mode is executed, the computing unit performs the image processing in the net ready image processing mode.

12. The image processing apparatus according to claim 8, wherein if the user interface gives an instruction in the copy operation, the scan operation, and the printer operation when image processing is performed in the net ready image processing mode, the image processing unit processes an image in an indicated operating mode and the computing unit performs the image processing in the net ready image processing mode.

13. The image processing apparatus according to claim 9, wherein if an instruction in image processing in the net ready image processing mode is given from the outside when one of the copy operating mode, the scan operating mode, and the printer operating mode is executed, the computing unit performs the image processing in the net ready image processing mode.

14. The image processing apparatus according to claim 9, wherein if an instruction in the copy operation, the scan operation, and the printer operation is given from the outside when image processing is performed in the net ready image processing mode, the image processing unit processes an image in an indicated operating mode and the computing unit performs the image processing in the net ready image processing mode.

15. The image processing apparatus according to claim 3, further comprising an image data retaining unit connected to the system control unit, which temporarily retains image data, and
wherein the system control unit includes a job request queue which stores job requests of the copy operating mode, the scan operating mode, the printer operating mode, and the net ready image processing mode, and a scheduling control unit which schedules a plurality of jobs as to a sequence of the jobs and a selection between the image processing unit and the computing unit to perform the net ready image processing, based on a predetermined evaluation function in such a manner that an evaluation value of the evaluation function is optimized, when the jobs are placed in the job request queue.

16. The image processing apparatus according to claim 15, wherein the evaluation function is used to evaluate an execution time of each of the jobs placed in the job request queue.

17. The image processing apparatus according to claim 15, wherein the evaluation function is used to evaluate an execution time of a job other than jobs for the net ready processing operation, which are included in the jobs placed in the job request queue.

18. A method of processing an image of an image processing apparatus, comprising:
executing at least one of a copy operating mode, a scan operating mode, and a printer operating mode to process an image using an image processing unit;
storing image data generated in the one of the copy operating mode, the scan operating mode, and the printer operating mode; and
executing a net ready image processing mode to process the stored image data using one of the image processing unit and a computing unit which processes image data.

19. The method according to claim 18, wherein the computing unit processes an image in the net ready image processing mode when the net ready image processing mode competes with at least one of the copy operating mode, the scan operating mode, and the printer operating mode.
